(19) United States
(12) Patent Application Publication
(10) Pub. No.: US 2019/0327195 A1
(43) Pub. Date: Oct. 24, 2019

(54) MESSAGE TRANSMISSION BLOCKING METHOD

(71) Applicant: Hyung Chul LIM, Seoul (KR)

(72) Inventor: Hyung Chul LIM, Seoul (KR)

(21) Appl. No.: 16/078,583

(22) PCT Filed: Feb. 23, 2017
(86) PCT No.: PCT/KR2017/002021

§ 371 Date: Nov. 23, 2018

(30) Foreign Application Priority Data
Feb. 23, 2016 (KR) 10-2016-0020903
Jan. 19, 2017 (KR) 10-2017-0009067

(51) Int. Cl. H04L 12/58

(52) U.S. Cl. CPC H04L 51/12; H04L 51/04

(57) ABSTRACT

Disclosed is a method of blocking transmission of a message. A method of blocking transmission of a message according to an embodiment of the present invention includes: receiving set information that blocks a message input of a user for each arbitrary chat room; and blocking a message input of the user in the arbitrary chat room for which the set information that blocks a message input is received.

### BACKGROUND OF THE INVENTION

### Field of the Invention

The present invention relates generally to a method of blocking transmission of a message. More particularly, the present invention relates to a method of blocking transmission of a message, the method being capable of blocking transmission of a message or fundamentally blocking a message input in a group chat room where a plurality of users have joined.

### Description of the Related Art

Recently, mobile devices such as smart-phones are widely used, and thus use of various applications by using the smartphone has also increased. Particularly, the use of mobile instant messaging programs to deliver messages quickly and easily between friends has also increased significantly.

As a result, the mobile instant messaging programs are the most frequently used programs in smart-phones and are used as an application to communicate with friends more frequently than a phone call.

In addition, as use of a PC version of a mobile instant messaging program has become common, and the PC version of a mobile instant messaging program is installed in one's own PC, a method using the same by synchronizing with the mobile instant messaging program is also widely used.

Such instant messaging programs provide a function so called “group chatting” enabling a plurality of users to communicate in a single chat room. As a result, a number of users use a group chat room of the instant messaging program to communicate a plurality of friends, co-workers, families, etc.

However, when a number of group chat rooms that a user has joined increases, a problem occurs where the user inputs an unintended message in a specific group chat room may.

For example, in a group chat room for sharing family events or business related announcements and to which tens or hundreds of co-workers have joined, a problem may occur in that a user may mistakenly input a private message that may be shared only with a dose friend or a boyfriend or girlfriend in the corresponding group chat room and transmits the same.

Considering that a user who uses the instant messaging program generally uses a plurality of individual chat rooms or group chat rooms, the above problem may occur to anyone.

In addition, a problem may occur in that a user may miss-select a conversation partner and transmit an inappropriate message when selecting at least one conversation partner from a plurality pre-registered friend lists.

Accordingly, there is a need for a method of blocking transmission of a message for a case where a user unintentionally inputs a message in a generated group chat room or for a case where a user miss-selects a conversation partner and transmits an inappropriate message.

The foregoing is intended merely to aid in the understanding of the background of the present invention, and is not intended to mean that the present invention falls within the purview of the related art that is already known to those skilled in the art.

Technical problems obtainable from the present disclosure are not limited by the above-mentioned technical problems, and other unmentioned technical problems may be clearly understood from the following description by those having ordinary skill in the technical field to which the present disclosure pertains.

### SUMMARY OF THE INVENTION

Accordingly, the present invention has been made keeping in mind the above problems occurring in the related art, and the present invention is intended to provide a method of blocking transmission of a message, the method being capable of blocking in advance a message input in a specific group chat room according to a user set.

In order to achieve the above object, according to one aspect of the present invention, there is provided a method of blocking transmission of a message, the method including: receiving set information that blocks a message input of a user for each arbitrary chat room; and blocking a message input of the user in the arbitrary chat room for which the set information that blocks the message input is received.

According to another aspect of the present invention, there is provided a method of blocking transmission of a message, the method including: receiving set information that blocks a message input for at least one of a plurality of conversation partners included in a friend list; and blocking a message input to the conversation partner for which the set information that blocks the message input is received.

According to another aspect of the present invention, there is provided a method of blocking transmission of a message, the method including: receiving set information that blocks transmission of a message for at least one of a plurality of conversation partners included in a friend list; and blocking transmission of a message to the conversation partner for which the set information that blocks transmission of the message is received.

According to another aspect of the present invention, there is provided a method of blocking transmission of a message, the method including: receiving set information that blocks a message input for at least one of a plurality of conversation partners included in a friend list; and blocking a message input or transmission of a message to a group chat room to which the conversation partner for which the set information that block the message input is received has joined.

According to another aspect of the present invention, there is provided a method of blocking transmission of a message, the method including: receiving set information that blocks transmission of a message input for at least one of a plurality of conversation partners included in a friend list; and blocking a message input or transmission of a message to a group chat room in which the conversation partner for which the set information that block the message input is received has joined.

According to a method of blocking transmission of a message according to an embodiment of the present invention, a situation can be prevented where a user transmits a message unintentionally to a group chat room, and becomes embarrassed.

In addition, blocking the possibility of transmitting an inappropriate message in advance to whom the user rarely transmits a message can be available such that a situation where the user becomes embarrassed may not occur.

### BRIEF DESCRIPTION OF THE DRAWINGS

The above and other objects, features and other advantages of the present invention will be more dearly understood from the following detailed description when taken in conjunction with the accompanying drawings, in which:

FIG. 1 is a view of a flowchart showing a method of blocking transmission of a message in an arbitrary chat room according to an embodiment of the present invention;

FIG. 2 is a view showing receiving set information that blocks input of a user message in an arbitrary chat room according to an embodiment of the present invention;

FIG. 3 is a view showing a method of blocking input of a user message in an arbitrary chat room where set information that blocks a message input is received according to an embodiment of the present invention;

FIG. 4 is a view of a flowchart showing a method of blocking transmission of a message in an arbitrary chat room according to another embodiment of the present invention;

FIG. 5 is a view showing rechecking whether or not to transmit a message to a user according to an embodiment of the present invention;

FIG. 6 is a view of a flowchart showing a method of blocking transmission of a message to an arbitrary conversation partner according to an embodiment of the present invention;

FIG. 7 is a view showing receiving of set information that blocks a message input according to an embodiment of the present invention;

FIG. 8 is a view showing blocking a message input to an arbitrary conversation partner according to an embodiment of the present invention;

FIG. 9 is a view of a flowchart showing a method of blocking transmission of a message to an arbitrary conversation partner according to another embodiment of the present invention;

FIG. 10 is a view showing blocking transmission of a message input by a user according to an embodiment of the present invention; and

FIG. 11 is a view of a flowchart showing a method of blocking inputting or transmitting a message in a group chat room according to an embodiment of the present invention.

### DETAILED DESCRIPTION OF THE INVENTION

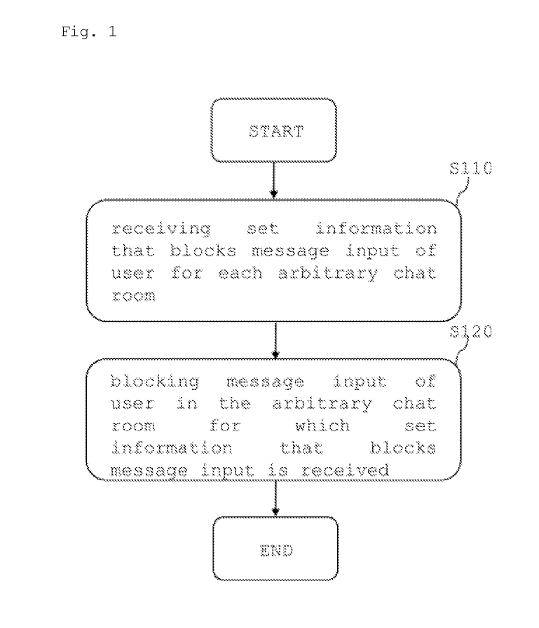

FIG. 1 is a view of a flowchart showing a method of blocking transmission of a message in an arbitrary chat room according to an embodiment of the present invention.

Hereinafter, for convenience, description will be given by omitting the subject of executing each step. However, each step described hereinafter may be executed by an instant messaging program or instant messaging application in which a message transmission blocking function according to an embodiment of the present invention is included.

Herein, the instant messaging program or instant messaging application may be installed in a user terminal device such as a smartphone, a desktop PC, a tablet PC, etc. However, an electronic device that may become the user terminal device is not limited thereto, and other general electronic devices may be used.

First, in S110, set information that blocks a message input from a user is received for each arbitrary chat room. A plurality of chat rooms to which a user has joined may be present in a single instant messaging program, and thus set information is received “for each chat room”.

For example, when a user has joined an A chat room, a B chat room, and a C chat room, and the A chat room is a group chat room and is a chat room to share business announcements, the user may rarely input a message in the A chat room.

Meanwhile, when the B chat room and the C chat room are chat rooms for private conversations with close friends, setting blocking of a message input for the B chat room and the C chat room is not necessary. Accordingly, set information that blocks a message input “for each chat room” is input by the user.

“Receiving set information that blocks a message input of a user” means that the user sets a function of disabling a message input in a corresponding chat room by himself of herself. For example, it may mean setting of activating a “message input blocking function” in instant messaging.

Subsequently, in S120, a message input from the user is blocked in an arbitrary chat room for which set information that blocks message input is received.

In the above example, when the user inputs set information that blocks a message input only for the A chat room, a message input by the user in the A chat room may be blocked.

When the user inputs a message in a chat room in which message input is blocked, a method for blocking the message may be \textcircled{1} “deactivating an area in which a message is input” or \textcircled{2} not displaying the input message.

According to a message blocking method according to an embodiment of the present invention, a problem in that an arbitrary user transmits an arbitrary message by mistake in a group chat room where a plurality of users have joined may be solved.

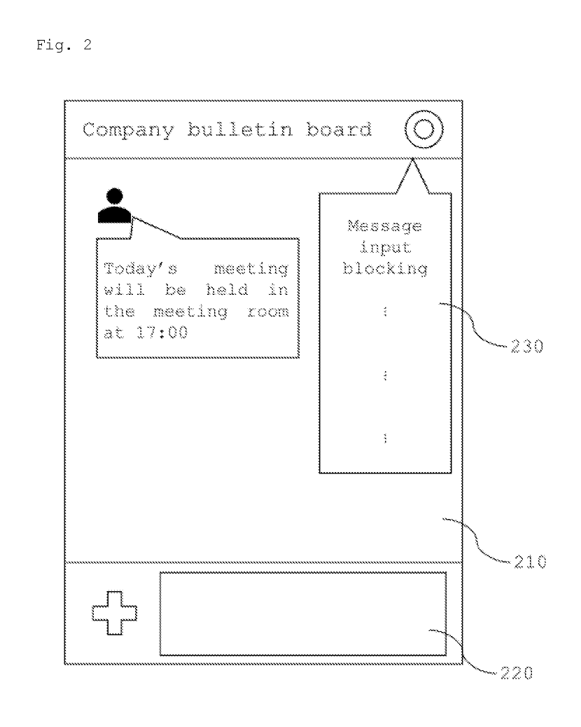

FIG. 2 is a view showing receiving set information that blocks a message input of a user in an arbitrary chat room according to an embodiment of the present invention.

As described above, “receiving set information that blocks message input” may mean, in detail, when a user selects a “message block setting function” included in the instant messaging application, the corresponding selection is input.

FIG. 2 is a view of a group chat room displayed in a smartphone, a desktop PC, etc. A group chat room according to an embodiment of the present invention includes a message display area 210 displaying messages transmitted from other users who have joined the group chat room, a message input area 220 for inputting a message to be transmitted, and a set information input area 230 for inputting set information related to the chat room.

The set information input area 230 according to an embodiment of the present invention may not be ordinarily displayed but may be activated and displayed in a screen when the user selects a set key. The user may activate a “message input blocking function” by selecting “message input blocking” displayed in the set information input area 230.

In an embodiment shown in FIG. 2, a user enters an arbitrary chat room and activates a “message input blocking function”, but activating a “message input blocking function” for each chat room may be implemented in a function menu capable of additionally inputting set information rather than entering the chat room.

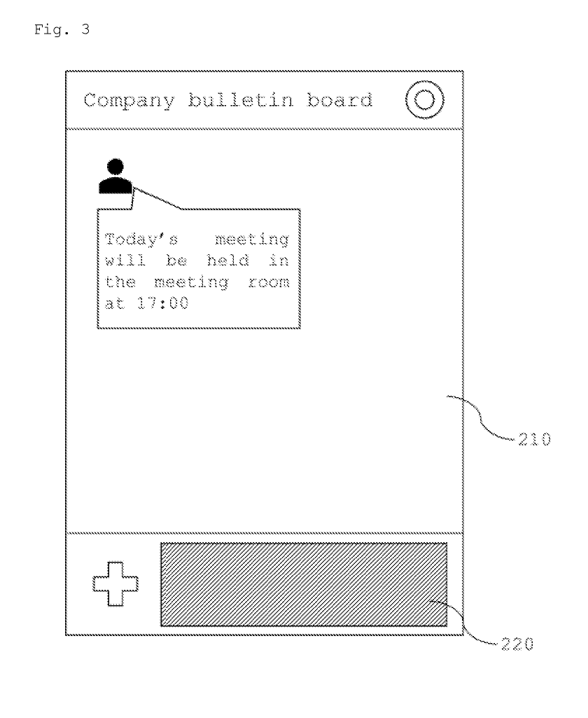

FIG. 3 is a view showing a method of blocking a message input of a user in an arbitrary chat room for which set information that blocks a message input is received according to an embodiment of the present invention.

According to an embodiment of the present invention, an area for inputting a message may be deactivated in a chat room for which set information that blocks a message input of a user is received. In detail, a message input area 220 may be deactivated as shown in FIG. 3.

Herein, deactivating an area for inputting a message means that an input message is not displayed in the message input area 220 even though the user inputs a message by using a user interface such as a touch screen, a keyboard, etc.

For example, a case where the user cannot select the message input area 220 or a case where a cursor that is ordinarily displayed in the message input area 220 is not displayed may correspond to the same.

However, a detailed method of blocking a message input of the user is not limited thereto, and a method of disabling message input while the message input area 220 is an active state may be implemented.

For example, a case may correspond to the same where an input message is not displayed in the message input area when a message is input in a chat room for which set information that blocks a message input is received.

In other words, even though a message is input through a user interface such as a touch screen, a keyboard, etc., under a state where a chat room for which message input is blocked is displayed in a user terminal device, thus the input message is ignored and is not displayed in the message input area.

Meanwhile, except for a case where the user blocks a message input in a chat room as described above, a method of allowing a message input, but not transmitting the input message may be used.

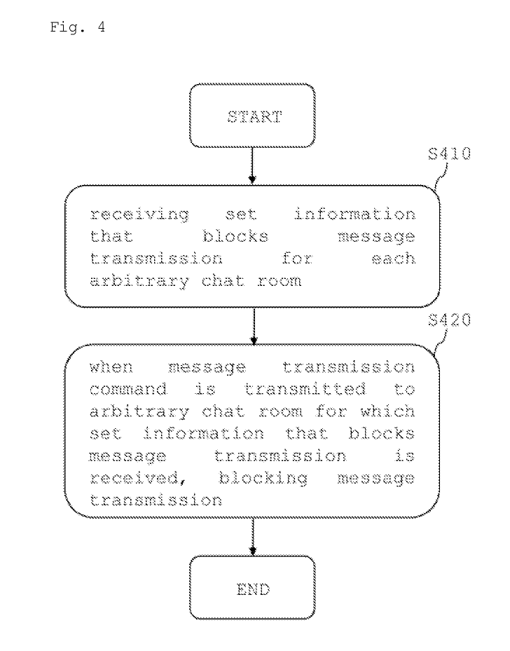

FIG. 4 is a view of a flowchart showing a method of blocking transmission of a message in an arbitrary chat room according to another embodiment of the present invention.

First, in S410, set information that blocks transmission of a message is received for each arbitrary chat room. A plurality of chat rooms a user has joined may be present in a single instant messaging program, and thus set information is received for each “chat room”.

For example, when the user has joined an A chat room, a B chat room, and C chat room, the user may input set information that block transmission of a message for the A chat room. Then, in S420, transmission of a message is blocked when a message transmission command is transmitted to an arbitrary chat room for which set information that blocks transmission of a message is received. For example, when the user inputs a specific message and selects a transmission button in the A chat room for which message transmission is blocked, transmission of the corresponding message is not performed.

Herein, blocking transmission of a message may mean not to transmit a message input from the user to an instant messaging server. However, when an instant messaging program directly transmits a message to a terminal device of another user rather than transmitting a message to another user through the instant messaging server, the same may mean not to transmit a message to a terminal device of another user.

Meanwhile, set information that blocks transmission of a message may be received by using a method similar to the method described with reference to FIG. 2.

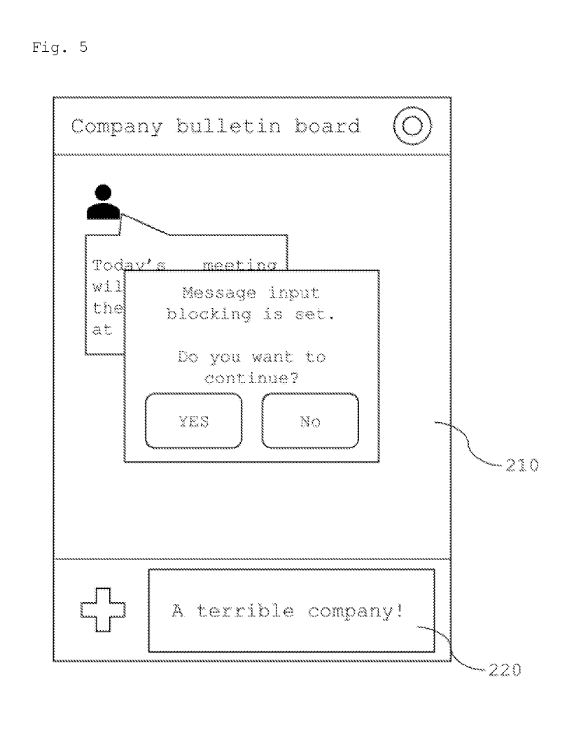

FIG. 5 is a view showing rechecking to a user whether or not to transmit a message according to an embodiment of the present invention.

According to a message transmission blocking method according to an embodiment of the present invention, when a message transmission command is transmitted to a chat room for which message transmission is blocked, an alarm message checking whether or not to transmit a message for which the transmission command has been transmitted may be displayed.

Herein, transmitting a message transmission command may mean that the user has input a specific message in the message input area 220 and selected a “transmission” button.

When a message transmission command is input even though set information that blocks transmission of a message is activated, an alarm message is displayed for rechecking whether or not to transmit the message.

When a confirm signal is input while the alarm message is displayed, the message is transmitted. Herein, having input the confirm signal may mean that the user has selected “YES” in the alarm message displayed in FIG. 5.

Accordingly, it is possible to prevent a situation where the user transmits a message unintentionally to users who have joined a group chat room, and becomes embarrassed.

Meanwhile, set information that blocks a message input or set information that blocks transmission of a message may be set for each arbitrary conversation partner.

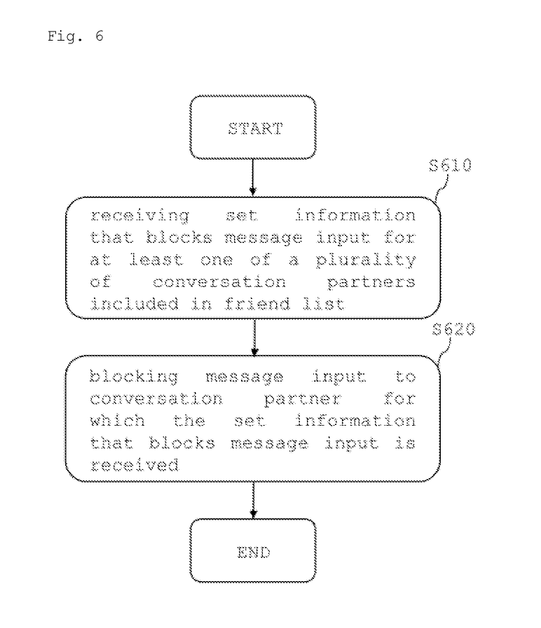

FIG. 6 is a view of a flowchart showing a method of blocking transmission of a message to an arbitrary conversation partner according to an embodiment of the present invention.

In order to block transmission of a message to an arbitrary conversation partner, first, in S610, set information that blocks a message input is received for at least one conversation partner among a plurality of conversation partners included in a friend list. Herein, the conversation partner means a person who is included in a friend list and can have a one-to-one conversation.

A general instant messaging program or instant messaging application generates a friend list from users who are registered in a phone book in association with the phone book of the user terminal device.

Then, when the user selects at least one of the plurality of conversation partners included in the friend list, a menu capable of executing a one-to-one conversation, voice over Internet protocol (VoIP), etc. with the selected conversation partner is displayed.

A message transmission blocking method according to an embodiment of the present invention may display a menu enabling a user to select set information that blocks a message input for a conversation partner when the user selects one of the plurality of conversation partners included in the friend list.

Among the conversation partners included in the friend list, a friend who intimate enough to share a formal conversation may be present but a person may be also present with whom the user has a business relationship or the person has higher social status than the user so that the user has to maintain polite conversation.

For example, the latter may be an employer, a spouse's family, or a user who has a business relationship with at work. Herein, when the user miss-selects a conversation partner or sends an inappropriate message with a loss of metal capacity such as in a drunken state, the user may become embarrassed. Accordingly, a function menu enabling the user to set blocking a message input for such a conversation partner is provided.

When set information that blocks a message input for an arbitrary conversation partner is received as described above, in S620, a message input to the conversation partner is blocked.

For example, when the user sets set information that blocks a message input by selecting a conversation partner “A”, a message input to “A” is blocked when the user selects the conversation partner “A” and inputs the message.

Hereinafter, receiving, in the instant messaging program or instant messaging application, set information that blocks a message input for each conversation partner, and a method of blocking message input will be described in detail.

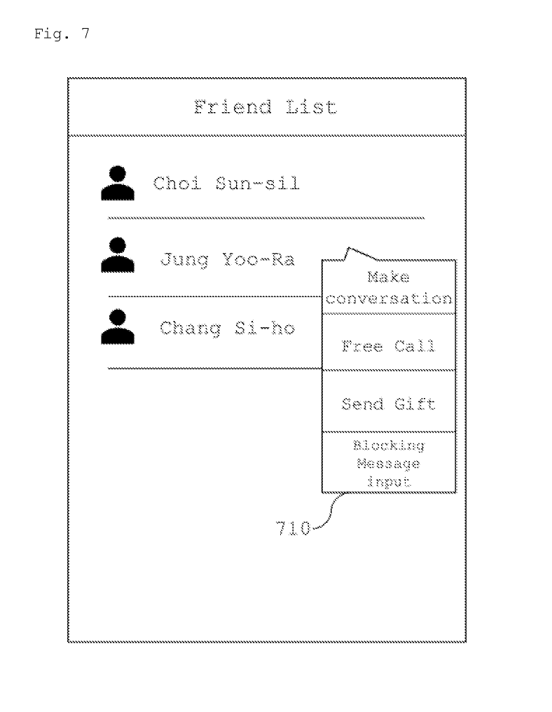

FIG. 7 is a view showing receiving of set information that blocks a message input according to an embodiment of the present invention.

A friend list displayed in the user terminal device is shown in FIG. 7. The instant messaging application displays a function menu 710 when a user selects a conversation partner, and enables the user to select a desired menu. Herein, when the user selects a “message input block” menu, a function of blocking a message input to the selected conversation partner is activated. Then, blocking a message input to the conversation partner to which the message input blocking function is activated by the user is performed.

In an embodiment shown in FIG. 7, when a user selects at least one of a plurality of conversation partners included in a friend list, a function menu 710 is activated, and a message input blocking function is activated by selecting a “message input block” menu in the function menu 710. However, activating a message input blocking function is not limited thereto, and as another global method, the function may be implemented by receiving set information.

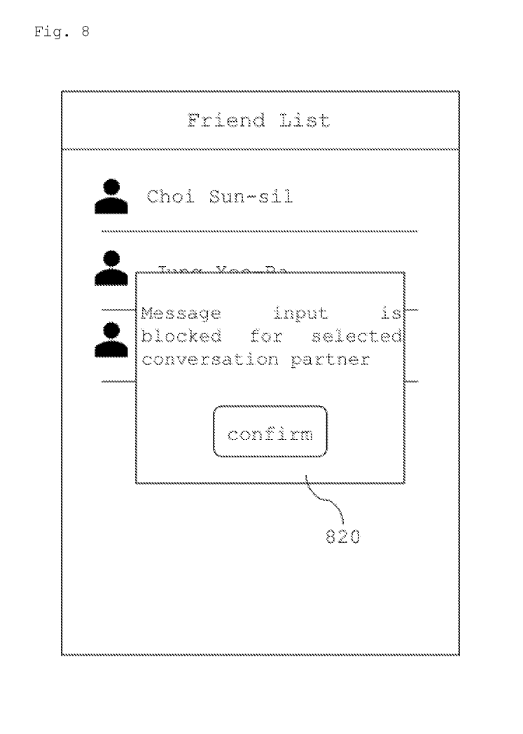

FIG. 8 is a view showing blocking a message input to an arbitrary conversation partner according to an embodiment of the present invention.

Generally, when a user selects one of a plurality of conversation partners included in a friend list, a chat room with the selected conversation partner is generated or a message capable of generating a chat room is displayed.

A message transmission blocking method according to an embodiment of the present invention may block generation of a chat room when a one-to-one conversation request is received for a conversation partner for which set information that blocks a message input is received. For example, a chat room may not be generated even though the user selects the conversation partner, or a chat room may not be generated even though a function menu generating a chat room is selected.

Additionally, when a one-to-one conversation request is received for a conversation partner for which set information that blocks a message input is received, an alarm message 820 is displayed that informs that the partner to whom the user has requested conversation is a user for which a “message input blocking function” is set while blocking generation of a chat room.

Accordingly, the user may set a message input blocking function by selecting in advance a conversation partner to whom the user rarely transmits a message and may cause the user to be embarrassed when an inappropriate message is transmitted to him or her, and thus blocking the possibility of transmitting a wrong message in advance is available.

Meanwhile, in the above embodiment, an example of blocking generation of a chat room with a conversation partner is described for blocking a message input, but blocking a message input may be performed by using another method.

According to an embodiment of the present invention, generation of a chat room with a conversation partner to whom a message input blocking function is set may be allowed, but inputting a message in the generated chat room may not be available.

For example, a message input area in which a message is input may be deactivated, or even though the user inputs a message by using a user interface such as a keyboard, a touch screen, etc., the message input by the user may not be displayed on the screen.

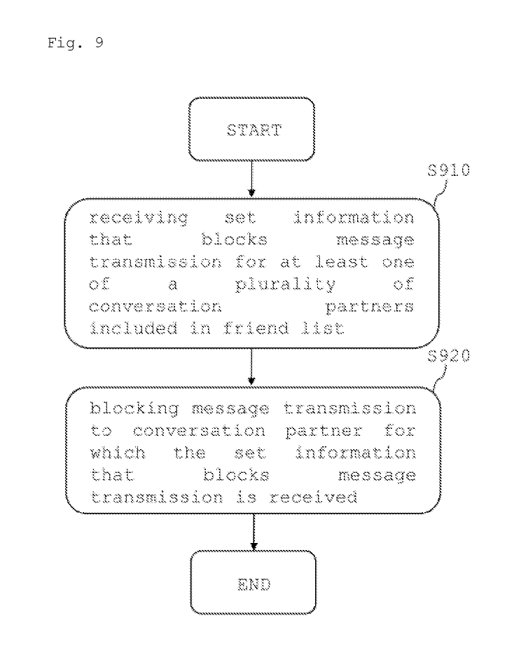

FIG. 9 is a view of a flowchart showing a method of blocking transmission of a message to an arbitrary conversation partner according to another embodiment of the present invention.

In order to block transmission of a message, first, in S910, set information that blocks transmission of a message is received for at least one conversation partner among a plurality of conversation partners included in a friend list.

Herein, blocking transmission of a message means that a user is able to input a message but the message is not transmitted to a conversation partner.

A function of blocking transmission of a message enables the user to select at least one conversation partner, and sets and activates the function of blocking transmission of a message for the corresponding conversation partner.

For example, as shown in FIG. 7, when one of conversation partners included in the friend list is selected, a function menu 710 for selecting various functions may be displayed. By selecting a message transmission blocking function included in the function menu 710, a message transmission blocking function for an arbitrary conversation partner may be activated.

When set information that blocks transmission of a message for an arbitrary conversation partner is received as described above, in S920, transmission of a message to the corresponding conversation partner is blocked.

Hereinafter, a method of blocking transmission of a message input by a user will be described.

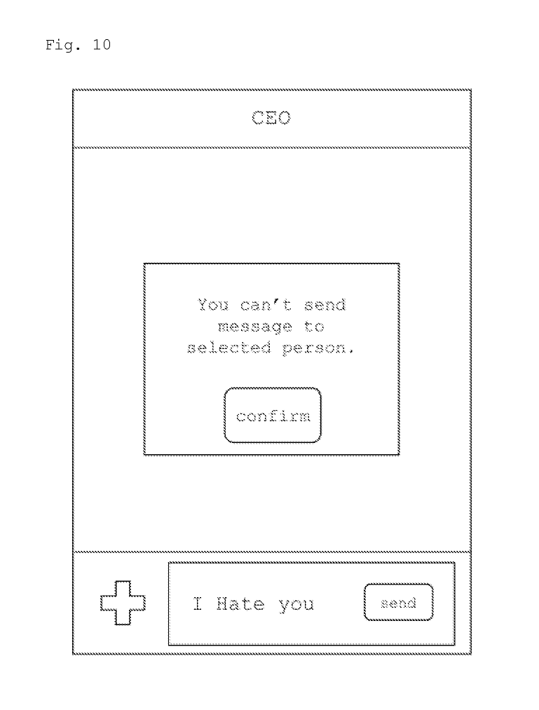

FIG. 10 is a view showing blocking transmission of a message input by a user according to an embodiment of the present invention.

When a user selects a conversation partner to whom a “message transmission blocking function” is set, a chat room capable of inputting a message to the selected conversation partner is generated. Then, when a message transmission command is received in the chat room with the conversation partner to whom a “message transmission blocking function” is set, transmission of a message is blocked.

Herein, an alarm message displaying that the conversation partner selected by the user is a conversation partner to whom a message transmission blocking function is set may be generated and displayed.

Accordingly, a situation where the user becomes embarrassed by miss-selecting a conversation partner by mistake and transmitting an inappropriate message to him or her may be prevented.

Meanwhile, the instant messaging program or instant messaging application may provide a group chat room function that provides conversation among a plurality of conversation partners as described with reference to FIGS. 1 to 5.

The user may generate a group chat room by inviting a plurality of conversation partners, or may be joined in a group chat room generated by another user by being invited.

In a group chat room generated as described above, a conversation partner to whom the user has set a message input blocking or message transmission blocking function may be present. For the above case, a method of blocking transmission of a message according to an embodiment of the present invention may block a message input or block transmission of a message in the corresponding group chat room when a conversation partner to whom the user has set a message input blocking or message transmission blocking function is included among conversation partners have joined the group chat room.

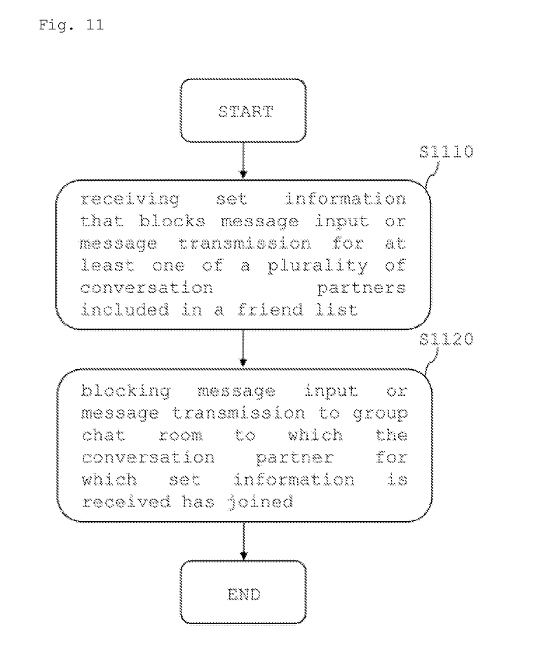

FIG. 11 is a view of a flowchart showing a method of blocking a message input or transmitting a message in a group chat room according to an embodiment of the present invention.

Receiving set information that blocks a message input or transmission of a message for at least one of a plurality of conversation partners included in a friend list, S1110, is identical as described with reference to FIGS. 6 to 10, and thus an overlapped is description will be omitted.

Subsequently, in S1120, when a conversation partner to whom a message input or message transmission blocking function is set is present in a group chat room the user has joined, a message input or transmission of a message in the corresponding chat room is blocked.

In addition to a case where a small number of conversation partners are present in a group chat room, and a case where a large number of conversation partners are present is also possible. Herein, a case where the user transmits an inappropriate message before the user checks conversation partners who are joined in the group chat room may occur.

Accordingly, a method of blocking transmission of a message according to an embodiment of the present invention blocks a message input of transmission of a message in a corresponding group chat room when a conversation partner to whom the user has set blocking a message input or transmission of a message is present in the group chat room.

For example, when the user has input set information that blocks a message input or transmission of a message for a conversation partner “A” and the user is joined in an arbitrary group chat room with the conversation partner “A”, a message input or transmission of a message in the corresponding group chat room is blocked.

As a method of blocking a message input, disabling a message input may be performed by deactivating a message input area or by not displaying a message input by the user by using a user interface such as a keyboard, a touch screen, etc. as described above.

Alternatively, transmission of a message may be blocked by allowing a message input but not transmitting the input message.

According to a method of blocking transmission of a message according to an embodiment of the present invention, a case can be prevented where a user miss-selects a conversation partner and transmits an inappropriate message, and thus user convenience can be achieved.

Meanwhile, the above-described method may be written as a computer-readable program and implemented using a computer-readable medium in a general-purpose digital computer. A data structure used in the method may be recorded on the computer-readable medium by various means. It is to be understood that program storage devices available to store a computer code executable to perform various methods of the present invention include temporal media such as carriers or signals. The computer-readable medium includes a storage medium such as a magnetic storage medium (e.g., Read Only Memory (ROM), floppy disk, and hard disk) or an optical reading medium (e.g., compact disk-read only memory (CD-ROM) or digital versatile disk (DVD)).

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A method of blocking transmission of a message, the method comprising:
receiving set information that blocks a message input of a user for each arbitrary chat room; and
blocking a message input of the user in the arbitrary chat room for which the set information that blocks the message input is received.

2. The method of claim 1, wherein the blocking of the message input of the user includes: deactivating a message input area of the arbitrary chat room.

3. The method of claim 1, wherein the blocking of the message input in the arbitrary chat room includes: when a message is input in the chat room to which blocking of the message input is set, not displaying the input message in the message input area.

4. A method of blocking transmission of a message, the method comprising:
receiving set information that blocks transmission of a message input by a user for each arbitrary chat room; and
when a message transmission command is transmitted to the arbitrary chat room for which the set information that blocks transmission of the message is received, blocking transmission of the message.

5. The method of claim 4, wherein when the message transmission command is transmitted to the arbitrary chat room for which the set information that blocks transmission of the message is received, the method further includes:
displaying an alarm message checking whether or not to transmit the message; and
transmitting the message to the chat room when the user inputs a confirm signal.

6. A method of blocking transmission of a message, the method comprising:
receiving set information that blocks a message input for at least one of a plurality of conversation partners included in a friend list; and
blocking a message input to the conversation partner for which the set information that blocks the message input is received.

7. The method of claim 6, wherein the blocking of the message input includes: when a one-to-one conversation request is received with the conversation partner for which blocking of the message input is received, blocking generation of a chat room with the corresponding conversation partner.

8. A method of blocking transmission of a message, the method comprising:
receiving set information that blocks transmission of a message for at least one of a plurality of conversation partners included in a friend list; and
blocking transmission of a message to the conversation partner for which the set information that blocks transmission of the message is received.

9-11. (canceled)
